(19) United States
(12) Patent Application Publication
(10) Pub. No.: US 2004/0073569 A1
(43) Pub. Date: Apr. 15, 2004

(54) System and method for integrating a personal adaptive agent

(75) Inventors: Benjamin A. Knott, Round Rock, TX (US); Robert R. Bushey, Cedar Park, TX (US)

Correspondence Address: BAKER BOTTS L.L.P., PATENT DEPARTMENT, 98 SAN JACINTO BLVD., SUITE 1500, AUSTIN, TX, 78701-4039, US

(73) Assignee: SBC Properties, L.P., Reno, NV

(21) Appl. No.: 10/259,058

(22) Filed: Sep. 27, 2002

(51) Int. Cl. G06F 17/00; G06F 7/00

(52) U.S. Cl. 707/104.1; 705/1

(57) ABSTRACT

An automated system for communication with inquiries includes a customer behavior engine and an organization policy engine. The customer behavior engine produces a model? of a customer's behavior and preference. The organization policy created a model of the preferences of the organization. An automated agent considers the preferences of both the customer and the organization to facilitate communication with the customer.

### TECHNICAL FIELD OF THE INVENTION

The present invention relates in general to telecommunications and network equipment and more particularly to a system and method for integrating a personal adaptive agent for assisting customers and users.

### BACKGROUND OF THE INVENTION

Customers contact telecommunications companies in order to accomplish certain tasks such as ordering a specific service, inquiring about their bill, or requesting a repair service. Customers often experience frustration because of difficulties getting connected with the right person or system within the organization to handle their particular task.

Providing customer support is costly; providing support via live custom-support representatives to handle every customer support inquiry is usually cost prohibitive. Different forms of automated customer support such as voice activated support systems or touch-tone activated support systems are often employed to handle customer inquiries. These automated support systems, while typically less expensive than customer support representatives, are costly and may lead to customer dissatisfaction and frustration if not properly engineered. Where automated systems are utilized, the systems represent only the user in searching for information and are typically passive in the sense that the automated systems collect and retrieve information according to instructions but do not act on the information.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 shows a block diagram of an adaptive personal agent according to teachings of the present invention;

FIG. 2 depicts an automated system for responding to inquiries from telecommunications customers; and

FIG. 3 is a flow diagram of the operation of an automated customer response system according to the present disclosure.

### DETAILED DESCRIPTION OF THE INVENTION

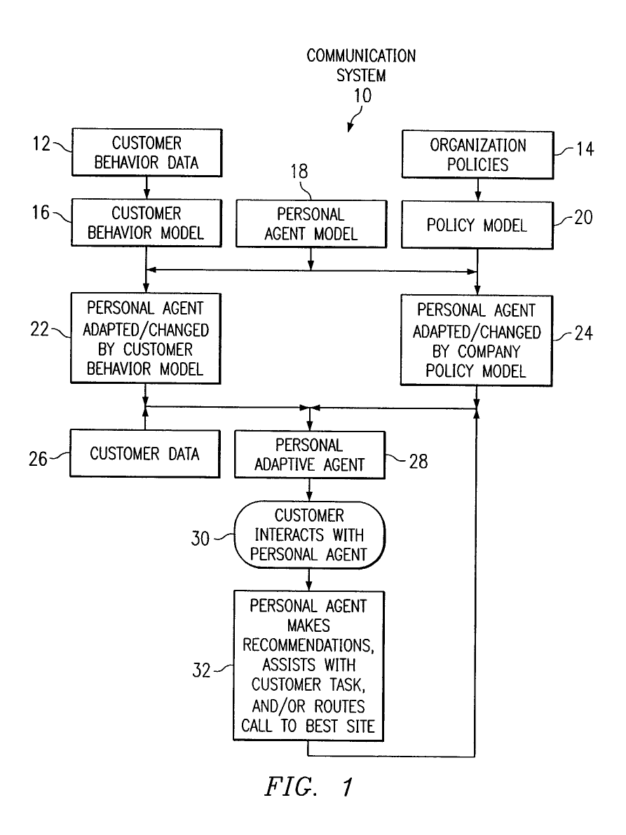

Preferred embodiments and their advantages are best understood by reference to FIGS. 1 through 3, wherein like numbers are used to indicate like and corresponding parts.

Now, referring to FIG. 1, a diagram of a communication system, indicated generally at 10 with an adaptive personal agent 28 is shown. Communication system 10 generally includes personal agent model 18, in operative communication with customer behavior model 16 and policy model 20. Customer behavior model 16 is preferably associated with a database containing customer behavior data, such as customer behavior database 12. Policy model 20 is preferably associated with a database containing policy information for a particular organization such as organization policy database 14.

In the present preferred embodiment, customer behavior model 16 formulates a model of customer behavior for individual customers using data within customer behavior database 12. For instance, customer behavior data 12 may include current and past service plan information, billing and payment history, service records, and submitted customer preferences for each customer. Customer behavior model 16 preferably incorporates the available customer behavior information to form a model. In one embodiment, customer behavior model 16 may characterize each customer with respect to selected themes or attributes such as technology adoption, cost preference, and payment timeliness. For instance, customer behavior model 16 may analyze a customer's current and past service plan to determine that a particular customer is frequently an early-adopter of new technology and services. One manner in which a customer may be identified as an early-adopter is if the customer's current service plan includes at least a pre-selected number of newly available services. Another manner in which a customer may be identified as an earlier adopter is if the customer has a history of requesting newly available technology or services. Yet another manner in which a customer may be identified as an early adopter of technology is if the customer voices the adoption of new technology as a preference such as in response to a survey or when opening a new account.

Customer behavior model 16 may also use past and current service plan information to determine that a customer's priority is to decrease cost. For instance, customer behavior model 16 may identify a customer as being cost-conscience if they historically have a low cost service plan. Customer behavior model 16 may also identify a customer as cost-conscience if the customer has submitted information indicating that their priority is to maintain a minimal level of service (e.g. service limited to only standard features and without additional services) for the lowest possible cost.

Customer behavior model 16 may similarly use past and current service plan information to determine that a customer's priority is to obtain the highest degree of value possible in their selected service plan. For instance, such a customer may not adopt additional features or service when they first become available and are often higher priced, but adopt new service plans that combine a number features at a lower price.

The model or characterization of a customer's priority for the early adoption of technology, low cost of service, or value of service may then be used to direct service and marketing efforts that align with the customer's priorities.

Additionally, customer behavior model 16 may characterize a customer's payment habits. For instance, customer behavior model 16 may evaluate a customer's payment history and characterize a customer as someone who routinely pays their bills on time, as someone who is routinely late with their payments, or fits into a category in between. In a particular embodiment, customer behavior model 16 may evaluate a customer's billing records for a selected period to characterize a customer's billing and payment habits.

In this manner, customer behavior model 16 may be used to focus marketing lower cost services to customers who have difficulty paying their bills and both the customer and the organization would stand to benefit. The customer will be better able to pay a lower bill and the company will be more likely to receive payment in a timely manner. Also, customer behavior model 16 can be used to focus marketing efforts for additional services on customers who timely pay their bills.

Organization policy data 14 may be accessed by policy model 20. Organization policy data 14 may include selected policy information and organization preferences. For instance, organization policy data 14 may include an organization's preference for increased sales, increased revenues, or increased numbers of customers. Organization policy data 14 may emphasize providing high levels of customer service in order to maintain current customers and may also emphasize particular services or features that an organization wants to sell. Further examples of organization policy include an organization's goal to increase or reduce the number of users of particular service packages.

Organization policy data 14 may be changed to reflect a change in organization policy. For instance, after considering the conditions of a particular consumer market, an organization may adopt a policy or goal, such as increasing the number of customers within a particular market or the revenue from a particular market. At other times the organization may focus on maintaining existing customers by placing customer satisfaction and securing customer loyalty as a priority. In another example, an organization may consider its ability to provide given services, including the organization's ability to install a particular service, in setting it policies.

Organization policy database 14 may be accessed by policy model 20 to form a model representing the goals and objectives of the organization. Because organization policies 14 may be updated to reflect changing organization policy, policy model 20 provides an up to date reflection of the goals and priorities of the organization.

Policy model 20 may be applicable to any type of organization that serves a customer or constituent base. In the present preferred embodiment, policy model 20 is particular to a business providing telecommunication services to customers.

Personal agent model 18 is adapted by both customer behavior model 16 and by policy model 20 to form personal adaptive agent 28. In the present embodiment, personal agent model 18 is adapted by customer behavior model 16 and policy model 20 in parallel as shown in blocks 22 and 24, respectively. In an alternative embodiment, persona agent model 18 may be adapted by customer behavior model 16 and policy model 20 in consecutive steps. Personal adaptive agent 28 also has access to customer data 26.

Customer data 26 includes, for each customer of the organization, information such as a telephone number, a physical address, and a billing address. Customer data 26 may also contain information such as a customer number or other unique identifier and alternative contact information such as an email address or mobile telephone number. In one particular embodiment of the present invention, customer data 26 may include service or billing information related to each customer. The information may include, for instance, a service order identifier and description for any pending service orders or the balance of the customer's account.

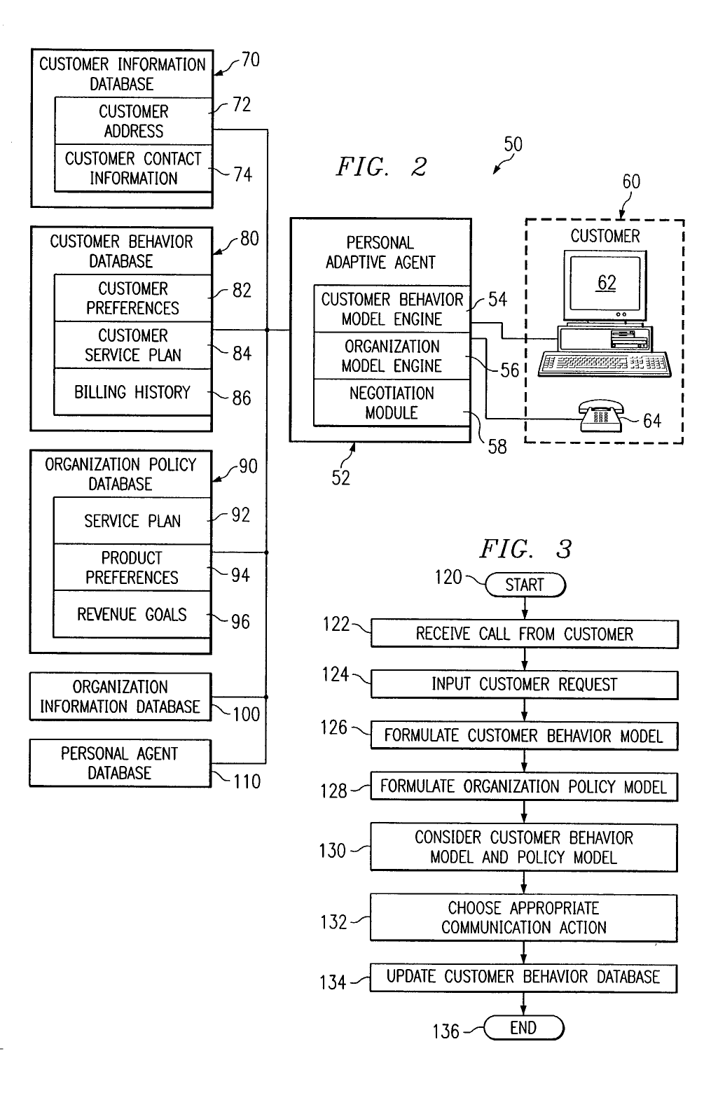

Personal adaptive agent 28 is formed with respect to each customer of an organization and operates to consider the preferences and needs of the customer as well as the policies and goals of the organization while assisting the customer communicate with the organization. Personal adaptive agent 28 includes information regarding the processes and procedures of the organization and the necessary information and steps required to respond to and satisfy most customer inquiries. Personal adaptive agent 28 has access to information. As described below with respect to FIG. 2, personal adaptive agent may include a variety of modules and components for receiving and analyzing information and for responding to customer requests.

Personal adaptive agent 28 may interact with customers in a number of different situations. In the present embodiment, Personal Adaptive Agent 28 may interact with a customer after a customer initiates communications with the organization 30. A customer may interact with personal adaptive agent using a touch tone interface, a voice activated interface, or another suitable interface such as a web-based interface or through an graphic user interface used with a personal digital assistant. During the initial interaction, personal digital assistant 28 communicates with customer to determine the nature of the customer's query. After determining the nature of customer's inquiry, personal agent 28 determines the steps necessary to complete the task or determine where the call should be routed 32 (if personal agent 28 cannot complete the task). Additionally, personal agent 28 may make a recommendation to the customer. For example, personal adaptive agent 28 may recommend that the customer switch to a different service plan.

In cases where personal adaptive agent 28 assists in completing a particular task in response to the customer's inquiry, personal adaptive agent uses available customer data 26 to complete the task.

In some cases, personal adaptive agent 28 may periodically determine whether a recommendation should be made to a particular customer. In cases where personal adaptive agent 28 determines that a recommendation is appropriate, personal adaptive agent 28 then contacts the particular customer and proffers the recommendation. The customer's response to the recommendation of personal adaptive agent 28 may be added to customer behavior data 12 to help further refine customer behavior model 16. Personal adaptive agent 28 may also evaluate a customer response to a trigger event such as when the organization introduces new products or service plans or when the new information is added to customer behavior database 12.

An example of the personal adaptive agent 28 serving the customer is that agent 28 will suggest a more inexpensive alternative (e.g. where the organization has recently issued a new long distance calling plan which is cheaper than the plan the customer had previously signed up for). Agent 28 may then assist the customer in changing over to the new, less costly plan—thus, saving money for the customer and increasing loyalty to the organization. An example of agent 28 serving the organization is where the agent may suggest slightly higher priced service package which includes two of the services that the customer already has plus additional useful and valuable services. In this example, the customer gains additional services and the organization increases revenues.

In the present embodiment, customer behavior model 16, personal agent model 18, and policy model 20 are carried out as a series of executable instructions stored on a physical medium. The executable instructions are then executed by a processor. These modules may exist as a separate and distinct software modules or _ engines or may be combined into a single software application. Either embodiment may be run by one or more processors.

In the present embodiment personal adaptive agent 28 is operable to receive input (such as a request from a customer) generate responses. The input that personal adaptive agent 28 receives may include, for example, a request for a new service, a question about billing, or a request for repair. The responses generated by personal adaptive agent 28 to the received input may consider the input from the customer, customer behavior module 16, and policy module 20.

Now referring to FIG. 2, a communication system, depicted generally at 50, is shown, communication system 50 includes personal adaptive agent 52. Personal adaptive agent 52 includes customer behavior modeling again for generating a model of behavior for individual customers. Personal adaptive agent 52 also includes an organization modeling engineer 56 and a negotiation module 58. Personal adaptive agent 52 communicates with customer 60 via a telephone 64, a computer 62 (such as through network interface or email), or another suitable form of communication.

Personal adaptive agent 52 may also access customer information database 70, customer behavior database 80, organization policy database 90, organization information database 100, and personal agent database 110.

Customer behavior modeling engine 54 operates to form the customer behavior model described with respect to FIG. 1. In the project embodiment, customer behavior model engine 54 accesses information including customer preferences 82, customer service plan 84, and billing history 86 to form an appropriate model. Alternate embodiments may incorporate additional types of customer behavior information in generating the customer behavior model. Other alternative embodiments of customer behavior modeling engine may focus on only one or two of these types of customer behavior information. In the present embodiment, customer behavior database 80 includes customer preferences 82, customer service plan information 84, and billing history information 86.

Organization model engine 56 considers information related to the preferences and goals of the organization such as those stored in organization policy database 90. Organization policy database 90 includes the organization's service plan preferences 92 and product preferences 94, as well as the organization's revenue goals 96. In alternate embodiments additional organization policy information, such as sales goals, profitability requirements, installation limitations, and customer satisfaction goals, may be incorporated into organization policy database 90 and the resulting organization policy model.

Negotiation module 58 considers the results of customer behavior modeling engine 54 and organization model engine 56 to determine what recommendations personal adaptive agent 52 should provide. In instances where the customer behavior model and the organization policy model have similar aims, personal adaptive agent 52 formulates a recommendation to achieve the common aims of customer and organization. In the present preferred embodiment, where the goals of the customer and the organization are in disagreement, the satisfaction of the customer is always held above the satisfaction of organizational policies. In some instances, where the preferences of the customer and the organization are in disagreement, personal adaptive agent 52 may decline to provide a recommendation to customer 60. It should be noted that instances of not providing a recommendation are primarily directed towards instances where personal adaptive agent is not responding to a specific customer inquiry but is instead evaluating customer and organization models periodically or as the result of a trigger.

In one embodiment, negotiation module 58 includes a number of rules. The primary rule is that where there is no conflict between customer interests and organization interests, then the agent may be adapted/changed to its new configuration. The second rule is to provide value for the customer. Where a less expensive way to accomplish a customer goal (e.g. set of services) is determined, that new plan is recommended. A third rule is that the more services purchased the better. Where the agent determines a logical way for the customer to purchase additional services, then the agent can recommend that action.

Personal adaptive agent 52 also operates to assist a customer in performing specific tasks such as changing to a different service plan, adding or removing particular features or options to a service plan, finding a walk-in payment location, requesting repair service, or another task. In completing a task, personal adaptive agent 52 accesses organization information database 100 to determine the steps and information required to complete the desired task. Personal adaptive agent also accesses customer information database 70 to aid in the completion of a customer task. Where customer information such as a customer address 72 or customer contact information is needed to complete a task, personal adaptive agent inputs information from customer information database 70 instead of requesting the information from customer 50.

In the instance where a customer is requesting a “walk-in” bill pay location, personal adaptive agent may compare the location of walk-in bill pay location stored in organization information database 100 with customer address 72 and direct customer 60 to the closet walk-in bill pay location.

In the present embodiment, each time that a customer behavior model is generated by customer behavior modeling engine 54 or an organization policy model is generated by organization model engine 56, the resulting model is stored within a file in personal agent database. In an alternative embodiment, modeling results may be stored only temporarily.

Now referring to FIG. 3, a flow diagram of a method according to the present invention is shown. The method begins at 120 when personal adaptive agent receives a call or other communication from a customer 122. The personal adaptive agent operates to input the request received from the customer 124. Next, personal adaptive agent formulates a customer behavior model 126 and an organization policy model 120 as described above. Personal adaptive agent then considers the resulting customer behavior model and organization policy model 130 and selects an appropriate communication action 132. As described above, the communication action selected may include directing the call to a customer service representative, aiding the customer in completing a specific task, or recommending a particular service plan or feature. Finally, the customer's response is recorded in the customer behavior database 134.

The method described above includes a number of advantages. One advantage is that new customer behavior information (e.g. a customer's response to a recommendation) is automatically processed to incorporate those behaviors into the behavior model. Another advantage of the invention is the ability of the system to automatically adapt the personal adaptive agent to change over time as customer behaviors and organization policies change. Yet another advantage is the ability of the system to automatically process the new organization policies in order to incorporate those policies into the policy model. Finally, the system provides improved customer service by providing the capability to provide assistance to the customer in the form of recommending improvements in service, providing factual information about services and features, and connecting the customer to the best service representative.

Although the disclosed embodiments and their advantages have been described in detail, it should be understood that various changes, substitutions and alterations can be made to the embodiments without departing from their spirit and scope.

What is claimed is:

1. An automated system for communicating with telecommunication customers comprising:
a customer information database for storing customer information for a plurality of telecommunications customers, including a customer address and a customer phone number for each telecommunications customer;
a customer behavior database for storing customer behavior data for the plurality of telecommunications customers including customer preferences, customer service plan information, and customer billing history information for each telecommunications customer;
an organization policy database for storing organization policy preferences;
a customer behavior engine operable to access information stored within the customer behavior database and generate a customer behavior model;
an organization engine operable to access the policy database and generate an organization policy model;
a negotiation module operable to compare the organization policy model and the customer behavior model and determine a communication action compliant with the organization policy model and the customer behavior model in response to a customer communication; and
the customer behavior engine further operable to receive a customer response to the communication action and amend the customer behavior model based upon the received customer response.

2. An automated system for responding to inquiries comprising:
an automated agent operable for facilitating customer and organization objectives comprising:
a customer behavior engine operable to access a customer behavior database and formulate a customer behavior model;
an organization policy engine operable to access and organization policy database and generate an organization policy model;
a negotiation module operable to compare the organization policy model and the customer behavior model and select a communication action in compliance with the behavior model and the policy model; and
the automated agent operable to transmit the communication action selected by the negotiation module to the customer in response to the received customer inquiry.

3. The automated system of claim 2 the automated agent operable to access a client information database.

4. The automated system of claim 2 further comprising the automated agent operable to act as both a customer representative and an organization representative.

5. The automated system of claim 2 further comprising the automated agent operable to receive a customer response to a communication action and update the customer behavior database to reflect the customer response.

6. The automated system of claim 2 further comprising the automated agent operable to receive a customer response to a communication action and update the customer behavior model to reflect the customer response.

7. The automated system of claim 2 further comprising the automated agent operable to receive a customer telephone inquiry.

8. The automated system of claim 2 further comprising the automated agent operable to receive a customer electronic mail inquiry.

9. The automated system of claim 2 further comprising the automated agent operable to receive a customer website inquiry.

10. The automated system of claim 2 wherein the automated agent:
periodically generates an organization model, and a customer behavior model;
determines a communication action based on a comparison of the customer behavior model and the organization model; and
carries out the communication action.

11. The automated system of claim 2 further comprising:
the automated agent operable to access a customer information database to facilitate the resolution of customer inquiries, the customer information database comprising customer address information, customer phone numbers, and customer service plan information.

12. The automated system of claim 2 further comprising:
the automated agent operable to receive a customer inquiry route the call to a recommended site for satisfying the customer inquiry; and
the automated agent operable to transmit customer information to the recommended site.

13. The automated system of claim 2 further comprising the communication action selected from the group consisting of recommending a service plan charge, connecting the customer to a service representative, and providing requested information.

14. An automated system for facilitating customer and organization communication comprising:
a customer behavior model,
an organization policy model,
a communication action database; and
an automated agent operable to compare the customer behavior model and the organization policy model and select an appropriate communication action from the communication action database.

15. The automated system of claim 14 further comprising:
a customer behavior engine operable to generate the customer behavior model from customer behavior information stored within a customer behavior database; and
an organization engine operable to generate the organization policy model from organization information stored within a policy database.

16. The automated system of claim 14 further comprising the automated agent operable to periodically update the customer behavior model and the organization policy model and to periodically compare the updated customer behavior model and the organization policy model to select an appropriate communication action.

17. A method for facilitating customer and organization communication comprising”formulating a customer behavior model;
formulating an organization policy model;
comparing the customer behavior model and the organization policy model; and
selecting an appropriate communication action based on the comparison.

18. The method of claim 17 wherein:
formulating the customer behavior model comprises considering customer behavior information stored within a customer behavior database; and
formulating the organization policy model comprises considering organization policy information stored within a policy database.

19. The method of claim 17 wherein formulating the customer behavior model comprises considering customer preferences.

20. The method of claim 17 wherein formulating the customer behavior model comprises considering customer payment history.
